(19) United States
(12) Patent Application Publication
(10) Pub. No.: US 2018/0074281 A1
(43) Pub. Date: Mar. 15, 2018

(54) TRIPLE-RING LENS FILTER HOLDER

(71) Applicant: MICROVIEW TECHNOLOGY CORP., Taoyuan City (TW)

(72) Inventor: Tzu-Shang HUANG, TAOYUAN CITY (TW)

(21) Appl. No.: 15/369,184

(22) Filed: Dec. 5, 2016

(30) Foreign Application Priority Data
Sep. 14, 2016 (TW) 105129958

(51) Int. Cl. G02B 7/02

(52) U.S. Cl. CPC G02B 7/026; G02B 7/021; G02B 7/025

(57) ABSTRACT

A triple-ring lens filter holder includes a front retaining ring, a middle retaining ring and a rear retaining ring. The front retaining ring has a front flange engaging an inner flange of the middle retaining ring. The rear retaining ring has a rear flange engaging an outer flange of the middle retaining ring. The inner flange of the middle retaining ring has an inner bevel surface formed on the inner flange to engage a first outer bevel surface formed on the front flange of the front retaining ring for the middle retaining ring to move relative to the front retaining ring. The rear flange of the rear retaining ring has a front bevel surface formed on the rear flange to engage a second outer bevel surface formed on the outer flange of the middle retaining ring for the rear flange to move relative to the middle retaining ring.

### BACKGROUND OF THE INVENTION

### 1. Field of the Invention

The present invention relates to a lens filter holder and, more particularly, to a triple-ring lens filter holder for easy assembly.

### 2. Description of the Related Art

A filter lens is an auxiliary device mounted in front of a lens for photography, which selectively absorbs light at different wavelengths in addition to lens protection to add special effects to image of photography works.

A conventional lens filter holder for multiple lenses includes a connection frame, a first pivoting frame and a second pivoting frame sequentially pivotally connected to each other. Polarizing filters may be securely respectively mounted inside the first pivoting frame and the second pivoting frame. Users can utilize a slide sleeve externally mounted on the first pivoting frame and the second pivoting frame to drive the first pivoting frame or the second pivoting frame to turn for adjusting the degree of polarization.

However, the conventional lens filter holder has problems that both cross-sections of outer connection flanges formed on outer sides of the first pivoting frame and the second pivoting frame and cross-sections of inner connection flanges formed on inner sides of the connection frame and the first pivoting frame are rectangular and there is no guiding structure formed between the outer connection flanges and the inner connection flanges that engage with each other for the outer connection flanges and the inner connection flanges to be slidably movable relative to each other upon assembly. Under even worse circumstances, it happens that the connection frame, the first pivoting frame and the second pivoting frame may not be assembled at all.

### SUMMARY OF THE INVENTION

An objective of the present invention is to provide a triple-ring lens filter holder with guiding bevel surfaces formed on flanges for engagement between the flanges and easy assembly of the triple-ring lens filter holder.

To achieve the foregoing objective, the triple-ring lens filter holder includes a front retaining ring, a middle retaining ring and a rear retaining ring.

The front retaining ring has a connection portion and a rear flange.

The connection portion is annularly formed on and axially protrudes from a rear portion of the front retaining ring.

The rear flange is annularly formed on and radially and outwardly protrudes from an outer side of the connection portion and has an outer surface, a front surface, a rear surface and a first outer bevel surface.

The first outer bevel surface is formed between the rear surface and the outer surface of the rear flange and obliquely and outwardly extends from the rear portion of the front retaining ring.

The middle retaining ring is resilient, is annularly mounted on a periphery of the front retaining ring, and has a shoulder portion, a sleeve portion, an inner flange, an abutment portion and an outer flange.

The shoulder portion radially extends and has an outer edge and an inner edge.

The sleeve portion axially extends from the outer edge of the shoulder portion to a front portion of the middle retaining ring.

The inner flange is annularly formed on and radially and inwardly extends from an inner side of the sleeve portion, engages the rear flange of the front retaining ring, and has an inner surface, a front surface, a rear surface and an inner bevel surface.

The inner bevel surface is formed between the front surface and the inner surface of the inner flange and obliquely and outwardly extends from the rear portion of the middle retaining ring.

The abutment portion axially and forwardly extends from the inner edge of the shoulder portion to the rear portion of the middle retaining ring.

The outer flange is annularly formed on and radially and outwardly extends from an outer surface of the abutment portion, and has an outer surface, a front surface, a rear surface and a second outer bevel surface.

The second outer bevel surface is formed between the rear surface and the outer surface of the outer flange and obliquely and forwardly extends from the rear portion of the middle retaining ring.

The rear retaining ring is resilient, is annularly mounted on a periphery of the shoulder portion of the middle retaining ring, and has a positioning portion and a rear flange.

The positioning portion is annularly formed on and axially extends from a rear portion of the rear retaining ring.

The rear flange is annularly formed on and radially and inwardly extends from an inner side of the positioning portion, engages the outer flange of the middle retaining ring, and has an inner surface, a rear surface and a front bevel surface.

The front bevel surface is connected with the inner surface of the rear flange, faces a front portion of the rear flange, and obliquely and forwardly extends from the inner surface of the rear flange.

Given the foregoing structure of the triple-ring lens filter holder, when the sleeve portion of the middle retaining ring is annularly mounted on the periphery of the front retaining ring, the inner bevel surface of the inner flange of the middle retaining ring abuts against the first outer bevel surface of the rear flange of the front retaining ring to guide the middle retaining ring to move relative to the front retaining ring, and when the rear retaining ring is annularly mounted on the periphery of the shoulder portion of the middle retaining ring, the front bevel surface of the rear flange of the rear retaining ring abuts against the second outer bevel surface of the outer flange of the middle retaining ring to guide the rear retaining ring to move relative to the middle retaining ring. Accordingly, the triple-ring lens filter holder can be assembled with ease.

Other objectives, advantages and novel features of the invention will become more apparent from the following detailed description when taken in conjunction with the accompanying drawings.

### BRIEF DESCRIPTION OF THE DRAWINGS

FIG. 1 is an exploded cross-sectional side view of a triple-ring lens filter holder in accordance with the present invention;

FIG. 2 is a partially enlarged cross-sectional side view of the triple-ring lens filter holder in FIG. 1; and

FIG. 3 is a partially enlarged exploded cross-sectional side view of the triple-ring lens filter holder in FIG. 1.

### DETAILED DESCRIPTION OF THE INVENTION

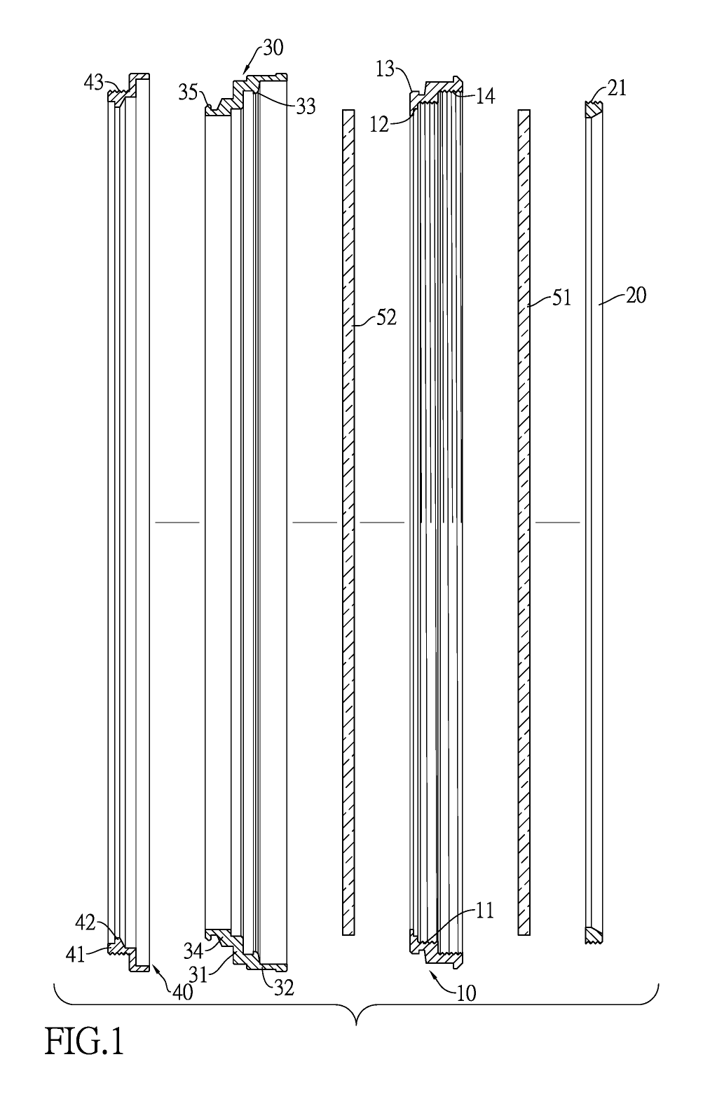

With reference to FIG. 1, a triple-ring lens filter holder in accordance with the present invention includes a front retaining ring 10, a compression ring 20, a middle retaining ring 30 and a rear retaining ring 40.

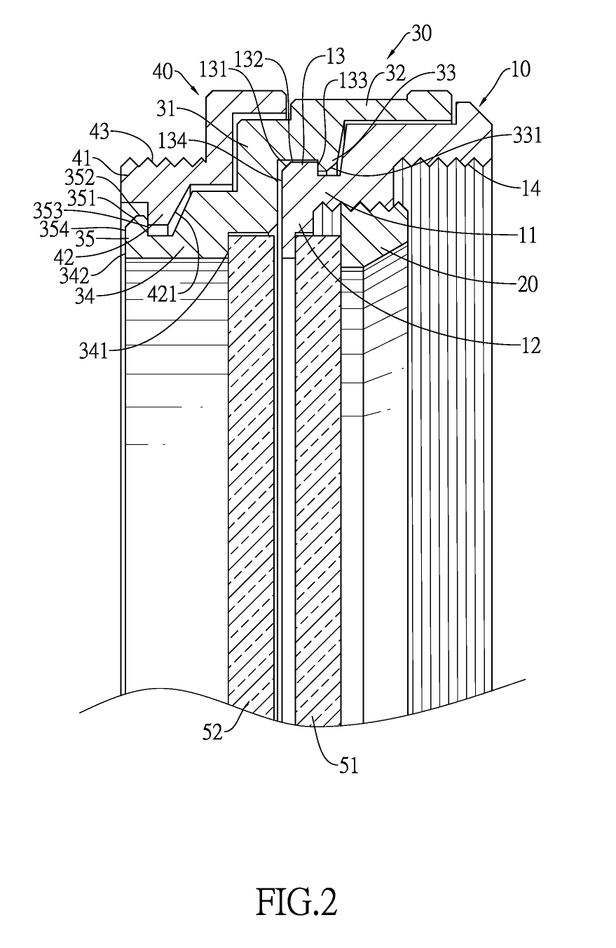

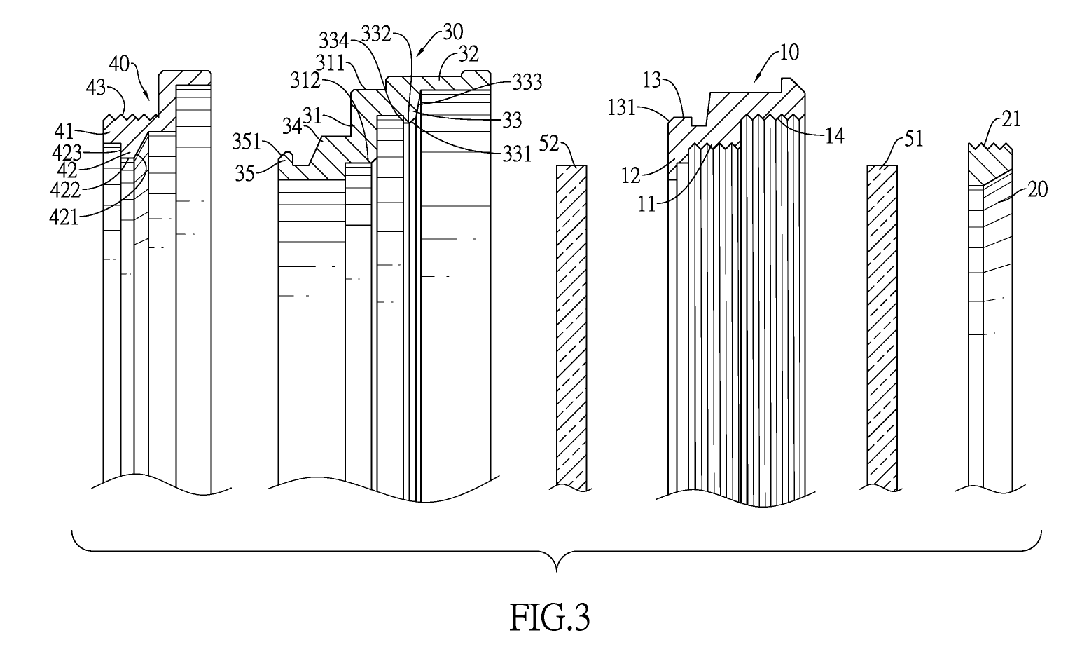

With reference to FIGS. 2 and 3, the front retaining ring 10 has a connection portion 11, a limiting flange 12, a rear flange 13 and an inner threaded portion 14. The connection portion 11 is annularly formed on and axially protrudes from a rear portion of the front retaining ring 10 and has a rear edge facing the rear portion of the front retaining ring 10. The limiting flange 12 is annularly formed on and protrudes radially and inwardly from an inner side of the connection portion 11, and is adjacent to the rear edge of the connection portion 11. The rear flange 13 is annularly formed on and protrudes radially and outwardly from an outer side of the connection portion 11, and has an outer surface 132, a front surface 133, a rear surface 134 and a first outer bevel surface 131. The front surface 133 faces a front portion of the front retaining ring 10. The rear surface 134 faces the rear portion of the front retaining ring 10. The first outer bevel surface 131 is formed between the rear surface 134 and the outer surface 132 and obliquely and outwardly extends from the rear portion to the front portion of the front retaining ring 10. The inner threaded portion 14 is annularly formed on the inner portion of the front retaining ring 10. A dustproof cover may be assembled on the front portion of the front retaining ring 10 to cover the triple-ring lens filter holder by engaging the inner threaded portion.

The compression ring 20 is detachably mounted on the connection portion 11 of the front retaining ring 10. A first lens 51 is held between the compression ring 20 and the limiting flange 12 of the front retaining ring 10. Specifically, the compression ring 20 has an outer threaded portion 21 annularly formed on an outer ring surface of the compression ring 20 for engagement with the connection portion 11 of the front retaining ring 10.

The middle retaining ring 30 is resilient and is annularly mounted on a periphery of the front retaining ring 10 and has a shoulder portion 31, a sleeve portion 32, an inner flange 33, an abutment portion 34 and an outer flange 35.

The shoulder portion 31 extends radially and has an outer edge 311 and an inner edge 312.

The sleeve portion 32 axially extends from the outer edge 311 to a front portion of the middle retaining ring 30. The inner flange 33 is annularly formed on and extends radially and inwardly from an inner side of the sleeve portion 32, and has an inner surface 332, a front surface 333, a rear surface 334 and an inner bevel surface 331. The front surface 333 faces the front portion of the middle retaining ring 30. The rear surface 334 faces a rear portion of the middle retaining ring 30. The inner bevel surface 331 is formed between the front surface 333 and the inner surface 332 of the inner flange 33 and obliquely and outwardly extends from the rear portion of the middle retaining ring 30.

When the sleeve portion 32 of the middle retaining ring 30 is annularly mounted on the periphery of the front retaining ring 10, the inner bevel surface 331 of the inner flange 33 of the middle retaining ring 30 abuts against and is moved along the first outer bevel surface 131 of the rear flange 13 of the front retaining ring 10. Meanwhile, the sleeve portion 32 of the middle retaining ring 30 is gradually propped up until the inner flange 33 of the middle retaining ring 30 passes the rear flange 13 of the front retaining ring 10. Owing to the elastic restoring force of the sleeve portion 32, the sleeve portion 32 returns to its undistorted state and the front surface 333 of the inner flange 33 of the middle retaining ring 30 abuts against the front surface 133 of the rear flange 13 of the front retaining ring 10, allowing abutment and engagement between the inner flange 33 of the middle retaining ring 30 and the rear flange 13 of the front retaining ring 10. Lubricant may be added between the front retaining ring 10 and the sleeve portion 32 of the middle retaining ring 30 to lower friction generated by relative rotation of the front retaining ring 10 and the middle retaining ring 30.

The abutment portion 34 axially and forwardly extends from the inner edge 312 of the shoulder portion 31 to the rear portion of the middle retaining ring 30 and has a connection edge 341 and a rear edge 342. The connection edge 341 is connected with the inner edge 312 of the shoulder portion 31. The rear edge 342 faces the rear portion of the front retaining ring 10. A second lens 52 is held between the limiting flange 12 of the front retaining ring 10 and the connection edge 341 of the abutment portion 34 of the middle retaining ring 30 and is adhered to the middle retaining ring 30 by adhesive. The outer flange 35 is annularly formed on and radially and outwardly extends from an outer surface of the abutment portion 34, and has an outer surface 352, a front surface 353, a rear surface 354 and a second outer bevel surface 351. The front surface 353 faces the front portion of the middle retaining ring 30. The rear surface 354 faces the rear portion of the middle retaining ring 30. The second outer bevel surface 351 is formed between the rear surface 354 and the outer surface 352 of the outer flange 35 and obliquely and forwardly extends from the rear portion of the middle retaining ring 30.

The rear retaining ring 40 is resilient, is annularly mounted on a periphery of the shoulder portion 31 of the middle retaining ring 30, and has a positioning portion 41, a rear flange 42 and an outer threaded portion 43. The positioning portion 41 is annularly formed on and axially extends from a rear portion of the rear retaining ring 40. The rear flange 42 is annularly formed on and radially and inwardly extends from an inner side of the positioning portion 41, and has an inner surface 422, a rear surface 423 and a front bevel surface 421. The rear surface 423 faces the rear portion of the rear flange 40. The front bevel surface 421 is connected with the inner surface 422, faces a front portion of the rear flange 42, and obliquely and forwardly extends from the inner surface of the rear flange 42. The outer threaded portion 43 is annularly formed on a periphery of the positioning portion 41 and engages an inner threaded portion formed inside a front portion of a camera lens for the triple-ring lens filter holder to be mounted on the front portion of the camera lens.

When the rear retaining ring 40 is annularly mounted on the periphery of the shoulder portion 31 of the middle retaining ring 30, the front bevel surface 421 of the rear flange 42 of the rear retaining ring 40 abuts against and is moved along the second outer bevel surface 351 of the outer flange 35 of the middle retaining ring 30. Meanwhile, the positioning portion 41 of the rear retaining ring 40 is gradually propped up until the rear flange 42 of the rear retaining ring 40 passes the outer flange 35 of the middle retaining ring 30. Owing to the elastic restoring force of the positioning portion 41 of the rear retaining ring 40, the positioning portion 41 returns to its undistorted state and the rear surface 423 of the rear flange 42 of the rear retaining ring 40 abuts against the front surface 353 of the outer flange 35 of the middle retaining ring 30, allowing abutment and engagement between the rear flange 42 of the rear retaining ring 40 and the outer flange 35 of the middle retaining ring 30. Lubricant may be added between the rear retaining ring 40 and the abutment portion 34 of the middle retaining ring 30 to lower friction generated by relative rotation of the rear retaining ring 40 and the middle retaining ring 30.

The triple-ring lens filter holder in accordance with the present invention is advantageous in that when the sleeve portion 32 of the middle retaining ring 30 is mounted on the periphery of the front retaining ring 10, the inner bevel surface 331 of the inner flange 33 of the middle retaining ring 30 and the first outer bevel surface 131 of the rear flange 13 of the front retaining ring 10 can be employed to guide the middle retaining ring 30 and the front retaining ring 10 to move relative to each other, and when the rear retaining ring 40 is mounted on the periphery of the shoulder portion 31 of the middle retaining ring 30, the front bevel surface 421 of the rear flange 42 of the rear retaining ring 40 and the second outer bevel surface 351 of the outer flange 35 of the middle retaining ring 30 can be employed to guide the rear retaining ring 40 and the middle retaining ring 30 to move relative to each other. Accordingly, the advantages of being simple and easy upon assembly of the triple-ring lens filter holder can be achieved.

Even though numerous characteristics and advantages of the present invention have been set forth in the foregoing description, together with details of the structure and function of the invention, the disclosure is illustrative only.

Changes may be made in detail, especially in matters of shape, size, and arrangement of parts within the principles of the invention to the full extent indicated by the broad general meaning of the terms in which the appended claims are expressed.

What is claimed is:

1. A triple-ring lens filter holder, comprising:
a front retaining ring having:
a connection portion annularly formed on and axially protruding from a rear portion of the front retaining ring; and
a rear flange annularly formed on and radially and outwardly protruding from an outer side of the connection portion, and having:
an outer surface;
a front surface;
a rear surface; and
a first outer bevel surface formed between the rear surface and the outer surface of the rear flange and obliquely and outwardly extending from the rear portion of the front retaining ring;
a middle retaining ring being resilient, annularly mounted on a periphery of the front retaining ring, and having:
a shoulder portion radially extending and having an outer edge and an inner edge;
a sleeve portion axially extending from the outer edge of the shoulder portion to a front portion of the middle retaining ring;
an inner flange annularly formed on and radially and inwardly extending from an inner side of the sleeve portion, engaging the rear flange of the front retaining ring, and having:
an inner surface;
a front surface;
a rear surface; and
an inner bevel surface formed between the front surface and the inner surface of the inner flange and obliquely and outwardly extending from a rear portion of the middle retaining ring;
an abutment portion axially and forwardly extending from the inner edge of the shoulder portion to the rear portion of the middle retaining ring; and
an outer flange annularly formed on and radially and outwardly extending from an outer surface of the abutment portion, and having:
an outer surface;
a front surface;
a rear surface; and
a second outer bevel surface formed between the rear surface and the outer surface of the outer flange and obliquely and forwardly extending from the rear portion of the middle retaining ring; and
a rear retaining ring being resilient, annularly mounted on a periphery of the shoulder portion of the middle retaining ring, and having:
a positioning portion annularly formed on and axially extending from a rear portion of the rear retaining ring; and
a rear flange annularly formed on and radially and inwardly extending from an inner side of the positioning portion, engaging the outer flange of the middle retaining ring, and having:
an inner surface;
a rear surface; and
a front bevel surface connected with the inner surface of the rear flange, facing a front portion of the rear flange, and obliquely and forwardly extending from the inner surface of the rear flange.

2. The triple-ring lens filter holder as claimed in claim 1, wherein
the front retaining ring further has a limiting flange formed on and protruding radially and inwardly from an inner side of the connection portion;
the triple-ring lens filter holder further comprises a compression ring detachably mounted on the connection portion of the front retaining ring, wherein a first lens is held between the compression ring and the limiting flange of the front retaining ring; and
the abutment portion further has a connection edge connected with the inner edge of the shoulder portion, wherein a second lens is held between the limiting flange of the front retaining ring and the connection edge of the abutment portion of the middle retaining ring.

3. The triple-ring lens filter holder as claimed in claim 2, wherein
the front retaining ring has an inner threaded portion annularly formed on an inner portion of the front retaining ring; and
the positioning portion of the rear retaining ring has an outer threaded portion annularly formed on a periphery of the positioning portion.

4. The triple-ring lens filter holder as claimed in claim 3, wherein the compression ring has an outer threaded portion annularly formed on an outer ring surface of the compression ring for engagement with the connection portion of the front retaining ring.

5. The triple-ring lens filter holder as claimed in claim 1, wherein lubricant is added between the front retaining ring and the sleeve portion of the middle retaining ring and between the rear retaining ring and the abutment portion of the middle retaining ring.

6. The triple-ring lens filter holder as claimed in claim 2, wherein lubricant is added between the front retaining ring and the sleeve portion of the middle retaining ring and between the rear retaining ring and the abutment portion of the middle retaining ring.

7. The triple-ring lens filter holder as claimed in claim 3, wherein lubricant is added between the front retaining ring and the sleeve portion of the middle retaining ring and between the rear retaining ring and the abutment portion of the middle retaining ring.

8. The triple-ring lens filter holder as claimed in claim 4, wherein lubricant is added between the front retaining ring and the sleeve portion of the middle retaining ring and between the rear retaining ring and the abutment portion of the middle retaining ring.

9. The triple-ring lens filter holder as claimed in claim 2, wherein the second lens is adhered to the middle retaining ring by adhesive.

10. The triple-ring lens filter holder as claimed in claim 3, wherein the second lens is adhered to the middle retaining ring by adhesive.

11. The triple-ring lens filter holder as claimed in claim 4, wherein the second lens is adhered to the middle retaining ring by adhesive.
